(19) United States
(12) Patent Application Publication
(10) Pub. No.: US 2017/0335509 A1
(43) Pub. Date: Nov. 23, 2017

(54) RETROREFLECTIVE YARNS AND THE PREPARATION METHOD THEREOF

(71) Applicant: Duksung Co., Ltd., Gyeonggi-do (KR)

(72) Inventors: Sung Jin KIM, Incheon (KR); Young Chul LEE, Gyeonggi-do (KR); Dal Rae JO, Gyeonggi-do (KR)

(21) Appl. No.: 15/597,455

(22) Filed: May 17, 2017

(30) Foreign Application Priority Data
May 20, 2016 (KR) 10-2016-0062106
May 15, 2017 (KR) 10-2017-0059913

(51) Int. Cl. D06M 15/572; D02G 3/36; C09D 5/33; C09D 7/12; D06M 11/83; D06M 11/79

(52) U.S. Cl. CPC D06M 15/572; D06M 11/83; D06M 11/79; C09D 5/004; C09D 7/1283; D02G 3/36

(57) ABSTRACT

The present invention relates to a retroreflective yarn coated with a composition for coating yarn comprising glass beads and an aqueous thermosetting urethane resin, and a method for producing the same.

The retroreflective yarn according to the present invention achieves a retroreflective function with high durability and high brightness.

### CROSS REFERENCE TO RELATED APPLICATIONS

This application claims priority to Korean patent applications serial number 10-2016-0062106 filed May 20, 2016, and 10-2017-0059913 filed May 15, 2017, both of which are incorporated herein by reference.

### TECHNICAL FIELD

The present invention relates to a retroreflective yarn coated with yarn coating polymer formulations comprising glass beads and aqueous thermosetting urethane resin composites and a process for its preparation.

The present invention relates to a retroreflective yarn produced by coating the yarn surface with polymer formulations comprising water-based thermosetting urethane resin and retroreflective glass beads, and a method for producing the same. The retroreflective yarns according to the present invention has an advantage of excellent physical properties such as strength and luminance and excellent durability.

### BACKGROUND ART

Generally, a luminous plate or a reflector is used for identifying a human body or an object at night or for non-power-emitting advertisement. However, the luminous plate has a disadvantage that the price thereof is expensive, and since the reflector is applied to clothes or shoes in the form of sheet or paint, the reflective plate is worn on a portion where the amount of activity is high or the human body is bendable. And when it is washed, it is peeled off from the clothes and there is a problem in its adhesion performance. Therefore, it is required to develop a retroreflective product which can be used without any problem even during intense activity or washing. In addition, marketability of retroreflective materials using light reflective markers and light reflecting films for night walking safety has been gradually increasing. Particularly, there is a growing interest in retroreflective yarns having high luminance according to the demands of fashionability

Korean Patent Application Laid-Open No. 2000-0059551 discloses a method of combining or covering a high strength yarn for reinforcing strength with a functional yarn slitted at a constant width of a film having a retroreflective function. However, this method is not suitable to be applied to a yarn for embroidery, sewing, weaving, knitting and the like due to a problem of residual torque of a yarn, a problem of degradation of functional yarns due to covering, a problem of productivity lowering due to a multistage process, due to difficulty in manifesting various colors, and so on.

Korean Patent Application Laid-Open No. 2005-0038390 discloses a retroreflective yarn obtained by covering a retroreflective sheet on a yarn or the like. The retroreflective yarn has problems such as poor durability, a difficult manufacturing process, and poor productivity.

Korean Patent Application Laid-Open No. 2001-0014677 discloses a retroreflective filament that is produced by a combination of a retroreflective material such as glass beads and a first polymer material capable of being spinnable therewith, and a second polymer material capable of spinning therewith. However, the retroreflective filament is disadvantageous in that productivity is deteriorated due to problems such as breakage of yarn during spinning, and the resin is not uniformly melted at the time of weight loss, resulting in uneven brightness.

### DISCLOSURE OF THE INVENTION

### Technical Problem

In order to solve the above problems, an object of the present invention is to provide a retroreflective yarn excellent in physical properties and low in density and excellent in durability and exhibiting a high-luminance retroreflective effect, by preparing a primary yarn coating composition by mixing a thermosetting urethane resin formulation containing a thermosetting urethane resin as a main component with an aluminum paste; coating the surface of the yarns with the primary yarn coating composition on in a single layer or in multiple layers; preparing a secondary yarn coating composition by mixing a water-based thermosetting urethane resin formulation containing a water-based thermosetting urethane resin as a main component with glass beads; and coating the surface of the yarns with the secondary yarn coating composition on in a single layer or in multiple layers.

### Solution to Problem

In order to achieve the above object, in one embodiment, a retroreflective element according to the present invention is produced by coating a surface of a yarn with a composition for primary coating comprising a thermosetting urethane resin and an aluminum paste, and then by coating the primary-coated yarn with a composition for secondary coating of a yarn comprising glass beads and aqueous thermosetting urethane composites, respectively.

According to one embodiment, a composition of a thermosetting resin including an aluminum paste may be first coated on the surface of a yarn, and then the aqueous thermosetting urethane composition containing glass beads as a retroreflective material may be coated on the outer circumferential surface of the yarn secondarily.

According to one embodiment, a manufacturing method according to the present invention includes a first step of preparing a composition for primary coating comprising an aluminum paste and a thermosetting urethane resin; a second step of coating the surface of a yarn with the primary coating composition to form a reflective layer; a third step of mixing a thermosetting urethane resin with a thickener, a processing aid, and glass beads to prepare a composition for secondary coating; and a fourth step of coating the surface of the yarn with the secondary coating composition.

The coatings of the second and fourth steps may be a single layer or a multilayer. After the coating, the coating is cured so as to adhere to the surface of the yarn, and then proceeds to the next step.

The composition for coating a yarn prepared according to the first step includes a thermosetting resin, and, in one embodiment, comprises 100 parts by weight of a thermosetting urethane resin, 10-40 parts by weight of an aluminum paste, and 30-60 parts by weight of a solvent.

The composition for coating a yarn prepared according to the third step comprises a water-based thermosetting resin, and, in one embodiment, comprises 100 parts by weight of a water-based thermosetting urethane resin, 1.5-2.5 parts by weight of a thickener, 1-5 parts by weight of a processing aid, and 50-300 parts by weight of glass beads.

It is preferable that the aqueous thermosetting urethane resin is any one of aqueous thermosetting silicone modified urethane, aqueous thermosetting polyurethane and aqueous thermosetting polyacryl urethane or a mixture thereof.

The thickening agent is preferably a polyacrylate, and the processing aid is composed of a matting agent (quencher), a dispersant, a crosslinking agent and, if necessary, a colorant, wherein the matting agent may be silica having a function of controlling gloss and tackiness of the coating layer, and it is preferable to use 2.5-3.5 parts by weight of silica if necessary. However, use of a matting agent may affect the luminance, and therefore, it is preferable not to use a matting agent. If it is used, it is preferable to use it as little as possible.

Usually, a colorant is not used, but when used, it is preferable to use an organic pigment having good transparency or a dye having high durability.

It is also preferable that the glass beads have an average particle diameter of about 15-100 μm.

### Advantageous Effects of the Invention

The retroreflective element according to the present invention is excellent in visibility and brightness at night even when it is used for clothes or shoes by using the retroreflective property of the glass bead by bonding the glass bead to the surface of the yarn, and it is excellent in durability and workability because it does not fall even if there is much bending or activity.

In addition, since apparatus or raw materials other than glass beads are not necessary for retroreflective property, it can be produced at a low cost, thereby increasing the productivity, and the glass bead is not damaged, thereby enhancing the completeness of production.

In addition, it minimizes yarn breakage caused by friction and lack of flexibility during high-speed operation such as embroidery or sewing, and effectively protects the retroreflective glass beads attached to the yarn, thereby achieving a strong durable and high brightness of retroreflective effect.

### BRIEF DESCRIPTION OF THE DRAWINGS

FIG. 1 is a schematic view showing a cross section of a retroreflective yarn according to the present invention.

FIG. 2 is a schematic view showing a side of a retroreflective yarn according to the present invention.

FIG. 3 is a scanning electron microscope (SEM) image of a cross section of a retroreflective yarn according to the present invention.

FIG. 4 is a scanning electron microscope (SEM) image of a side of a retroreflective yarn according to the present invention.

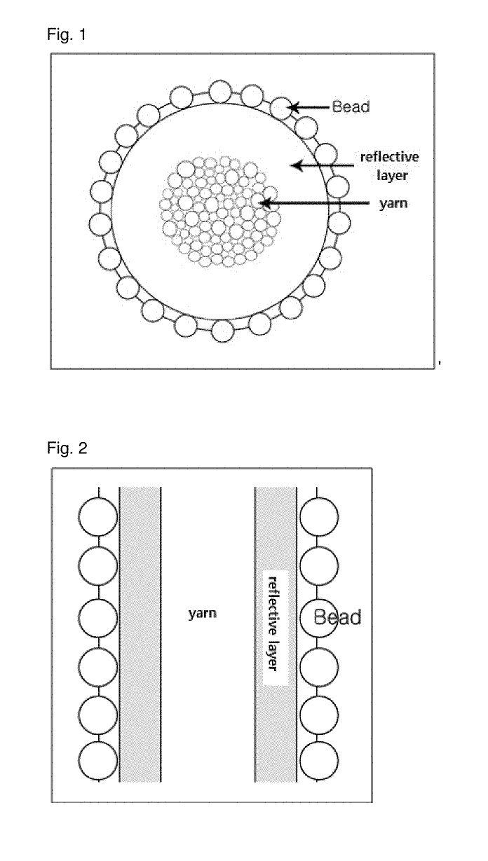

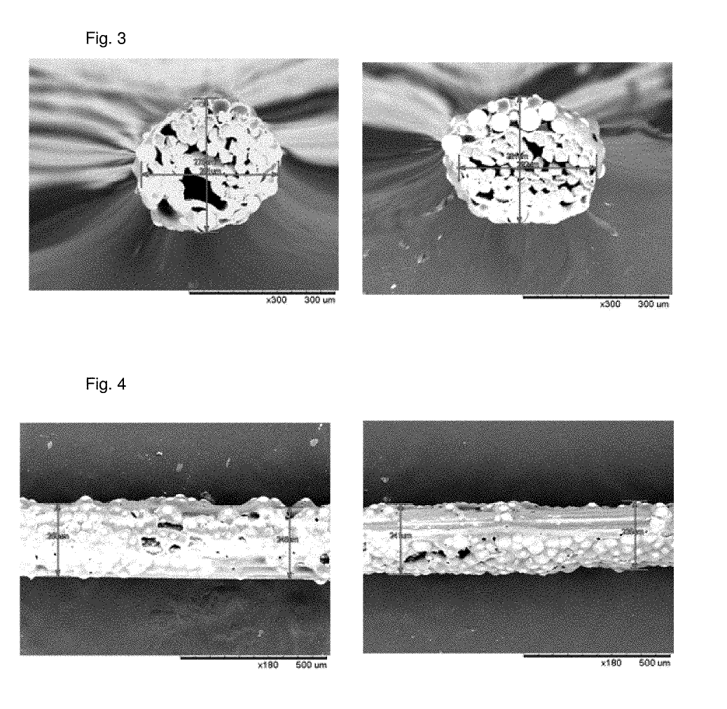

### BEST MODE FOR CARRYING OUT THE INVENTION

The present invention relates to a retroreflective yarn excellent in physical properties and low in density and excellent in durability and exhibiting a high-luminance retroreflective effect, and the manufacturing method thereof wherein a primary yarn coating composition is provided by mixing a thermosetting urethane resin formulation containing a thermosetting urethane resin as a main component with an aluminum paste; a secondary yarn coating composition is prepared by mixing a water-based thermosetting urethane resin formulation containing a water-based thermosetting urethane resin as a main component with glass beads; and the yarns are coated with the primary yarn coating composition in a single layer or in multiple layers and then coated with the secondary yarn coating composition in a single layer or in multiple layers. In addition, the present invention relates to a retroreflective yarn which can be applied to various fields, having flexibility, being excellent in physical properties by improving surface strength.

Hereinafter, a retroreflective yarn according to an embodiment of the present invention and a method for producing the same will be described in detail.

In one embodiment, a retroreflective yarn according to the present invention is prepared by coating the yarn with a primary coating composition comprising thermosetting urethane resin formulation and an aluminum paste in a single layer or in multiple layers, and is fully cured, followed by coating the primary-coated yarn with a secondary coating composition comprising a water-based thermosetting urethane resin formulation and glass beads and fully curing the same.

In order to increase the retroreflectivity, aluminum paste is added to a primary coating composition and glass beads are added to a secondary coating composition.

A composition for primary coating according to the present invention comprises a thermosetting resin, and for example, it comprises 100 parts by weight of a thermosetting urethane resin, 10-40 parts by weight of an aluminum paste, and 30-60 parts by weight of a solvent.

A primary coating yarn coating compound according to the present invention may be prepared by mixing a thermosetting urethane resin, a solvent, and an aluminum paste, and may be coated on the surface of a yarn such as polyester, nylon, or rayon.

A thermosetting resin for a primary coating may be any one selected from the group consisting of oil-based thermosetting urethane resin, oil-based thermosetting silicone-modified urethane, oil-based thermosetting polyurethane oil-based thermosetting polyacryl urethane, and a mixture thereof. For example, for example, one or two or three kinds of polyols such as a polyester polyol, a polycarbonate polyol, a polycaprolactone polyol, a polyether polyol, an acrylic or a silicone polyol are selected and reacted with a diisocyanate to produce a prepolymer, which are reacted with high molecular diols, diisocyanates, low molecular diols or diamines to produce thermosetting resin. When the resin thus produced is used, a coated yarn having a high tensile strength can be obtained.

The thickness of the primary coating layer (i.e., reflective layer) according to the present invention may be from 3 μm to 30 μm, in another embodiment from 5 μm to 20 μm, and in another embodiment from 8 μm to 10 μm.

The composition for secondary coating according to the present invention comprises an aqueous thermosetting urethane resin, and in one embodiment, it comprises 100 parts by weight of an aqueous thermosetting urethane resin, 1.5-2.5 parts by weight of a thickener, 1-5 parts by weight of a processing aid, 50-300 parts by weight of glass beads. If necessary, it may further comprise 2.5-3.5 parts by weight of a matting agent.

A secondary coating composition according to the present invention is prepared by mixing a water-based thermosetting urethane resin, a thickener, a processing aid, and a glass bead, which is coated on the surface of the primary coated yarn as a single layer or a multilayer.

Since the aqueous thermosetting urethane resin is water-soluble, a special solvent other than water is not necessarily required, and the desired viscosity can be easily controlled by adding a thickener while maintaining the required solid content.

An aqueous thermosetting urethane resin is selected from any one or a mixture of aqueous thermosetting silicone modified urethane, aqueous thermosetting polyurethane and aqueous thermosetting polyacryl urethane. For example, as the polyol, one or two or more of a polyester polyol, a polycarbonate polyol, a polycaprolactone polyol, a polyether polyol, an acrylic or a silicone polyol may be selected, and reacted with a dihydroxy compound having a hydrophilic group, a diisocyanate, if necessary, and glycols, etc. to prepare an NCO-terminal prepolymer and then dispersing it in water using a diamine as a chain extender.

As a thickening agent, preferably, polyacrylate is used, and a processing aid is composed of a matting agent, a dispersant, and a crosslinking agent, and the matting agent may be comprised in an amount of 2.5-3.5 parts by weight and is preferably silica.

A thickener is used for controlling the viscosity of the aqueous thermosetting urethane compound for improving the productivity and workability, and the desired amount is added according to the thickness of the coating layer coated on the yarn.

The thickener may be used in an amount of 1-10 parts by weight, in another embodiment 1.5-10 parts by weight, in another embodiment 2.5-10 parts by weight, or in another embodiment 1.5-2.5 parts by weight, based on 100 parts by weight of the aqueous thermosetting urethane resin. When the thickener content is higher than 10, since viscosity of the composition is higher, the coating agent is not uniformly coated. In case of the thickener content is less than 1, coating does not work properly due to low viscosity of the composition.

A processing aid is added to the aqueous thermosetting urethane resin so as to reduce the coefficient of friction between the nozzle and the aqueous thermosetting urethane coating layer when the coated yarn comes out from the nozzle and make no residue left on the nozzle. Thus, it is capable of reducing the defective ratio. Also, a processing aid improves the adhesion between the aqueous thermosetting urethane composition and the yarn to improve the coating property.

The processing aid may be used in an amount of 1-12 parts by weight, or 1-6 parts by weight, or 1-5 parts by weight, or 5-12 parts by weight, or 6-12 parts by weight, based on 100 parts by weight of the aqueous thermosetting urethane resin, and the above-mentioned contents achieves the great advantage in maintaining the physical properties. In addition, the processing aid generally may comprise a matting agent, a dispersant, and a crosslinking agent. Among the above ingredients, a matting agent may be used in an amount of 2.5-3.5 parts by weight, and a dispersant and a crosslinking agent are used in an appropriate amount depending on the amount and kind of the water-soluble thermosetting urethane resin.

Further, a matting agent is added to the aqueous thermosetting urethane resin and it is preferable that 2.5-3.5 parts by weight of a matting agent is added to 100 parts by weight of the aqueous thermosetting urethane resin.

A matting agent is used for quenching the reflected light from the surface of the coated yarn. The amorphous silica having an average particle diameter of 20 μm or less is used to form fine irregularities on the surface of the coated yarn to scatter or quench incident light, making the gloss of the coated yarn surface adjustable.

Glass beads are for imparting a retroreflective function to the yarn, and preferably has an average particle size of 15-100 μm, more preferably 20-80 μm, and more preferably 20-60 μm. In addition, the content of the glass beads is 10 to 300 parts by weight, or 15 to 250 parts by weight, or 20 to 300 parts by weight, or 30 to 100 parts by weight, or 50 to 150 parts by weight, or 20 to 200 parts by weight, or 50 to 300 parts by weight, based on 100 parts by weight of the aqueous thermosetting urethane resin.

Thus, a water-based thermosetting urethane resin is used as a base, and a proper amount of a thickener, a processing aid, and glass beads are mixed there into to produce a composition for coating a yarn.

The thickness of the secondary coating layer according to the present invention may be from 10 μm to 60 μm, in another embodiment from 20 μm to 50 μm, and in another embodiment from 30 μm to 50 μm.

A yarn may be nylon, polyester, rayon, polypropylene or the like.

The present invention will be explained in detail with reference to the following examples. However, these examples may be embodied in various different forms and the scope of the invention should not be construed as being limited thereto. The examples are provided to fully convey the invention to a person having ordinary knowledge in the art.

### Examples

The thermosetting urethane resin for primary coating (manufacturer: Duksung Co., Ltd., Korea) was a thermosetting polyurethane resin synthesized by using polyester polyol and aromatic diisocyanate (MDI), and had a solid content of 30% and a solvent of methyl ethyl ketone. The aluminum paste was mixed therewith to prepare a thermosetting polyurethane composition for primary coating. The above thermosetting polyurethane composition for primary coating comprised 50 parts by weight of a solvent, 26 parts by weight of an aluminum paste and 100 parts by weight of a thermosetting polyurethane resin.

Aqueous thermosetting urethane resin (manufacturer: Covestro) having a solid content of 40% or a water-based thermosetting urethane resin (manufacturer: Covestro) having a solid content of 60% were used for the secondary coating aqueous thermosetting urethane resin. A composition for secondary coating of yarn was prepared by mixing polyacrylate as a thickener, a crosslinking agent for a polyisocyanate-based aqueous resin as a processing aid, and glass beads in the aqueous thermosetting urethane resin.

The surface of the yarn was coated with the primary coating composition as a single layer, and then completely cured. Then, the secondary coating composition was coated thereon with a single layer and completely cured to produce a retroreflective yarn.

Table 1 shows the retroreflective effect for the retroreflective yarn produced according to Example 1.

TABLE 1

| | content of | solid content | | | | | | |
|---|---|---|---|---|---|---|---|---|
| | water-based | of water-based | | | glass | | | |
| | thermosetting | thermosetting | thicker | processing | beads | viscosity | coating | retro- |
| | urethane | urethane resin | content | aid content | content | (CPS, | work- | reflective |
| Example | resin (PHR) | (%) | (PHR) | (PHR) | (PHR) | 25° C.) | ability | effect |
| A-1 | 100 | 60 | 1 | 1 | 10 | 10,000 | Normal | Good |
| A-2 | 100 | 60 | 1.5 | 1 | 10 | 25,000 | Good | Good |
| A-3 | 100 | 60 | 10 | 2 | 15 | 70,000 | Normal | Good |
| B-1 | 100 | 40 | 1 | 3 | 20 | 8,000 | Normal | Good |
| B-2 | 100 | 40 | 1.5 | 1 | 30 | 25,000 | Good | Very |
| | | | | | | | | good |
| B-3 | 100 | 40 | 10 | 2 | 30 | 60,000 | Normal | Good |
| A-4 | 100 | 60 | 1 | 3 | 50 | 15,000 | Normal | Good |
| A-5 | 100 | 60 | 1.5 | 1 | 100 | 35,000 | Good | Very |
| | | | | | | | | good |
| A-6 | 100 | 60 | 10 | 5 | 100 | 85,000 | Normal | Good |
| B-4 | 100 | 40 | 1 | 5 | 150 | 20,000 | Normal | Good |
| B-5 | 100 | 40 | 1.5 | 1 | 200 | 25,000 | Good | Very |
| | | | | | | | | good |
| B-6 | 100 | 40 | 10 | 3 | 300 | 80,000 | Normal | Very |
| | | | | | | | | good |
| A-7 | 100 | 60 | 1.5 | 5 | 350 | 40,000 | unwork | — |
| (compara- | | | | | | | able | |
| tive | | | | | | | | |
| example) | | | | | | | | |
| B-7 | 100 | 40 | 1.5 | 5 | 500 | 35,000 | unwork | — |
| (compara- | | | | | | | able | |
| tive | | | | | | | | |
| example) | | | | | | | | |

As shown in Table 1, it can be seen that the viscosity increases as the content of the thickener increases. As a result of evaluation of coating workability, when the content of the thickener was 1.5 PHR, the most stable workability was obtained.

As a result of the evaluation of the retroreflectivity and workability according to the content of the glass beads, the retroreflectivity was weak when the content of the glass beads was 10-30 parts by weight. And when the content of the glass beads was 300-500 parts by weight, the retroreflectivity was normal, but due to the high content of beads, the nozzles were clogged during the coating operation and the operation was impossible. When the glass bead content was 50-300 parts by weight, the retroreflective property and workability were the most excellent.

In addition, when the water-based thermosetting urethane resin having a low solids content was used, 1.5 PHR of a thickener and 50-300 PHR of a glass bead were charged and the viscosity was adjusted to 25,000 cps, the best effect was obtained in workability and retroreflectivity.

Table 2 shows the results of the comparison of the tensile strengths among the retroreflective coating yarn according to the present invention, the retroreflective sheeting yarn (Korea Wigkorea [R/Yarn 1/69″ (both-sided)]), and the retroreflective filament composite yarn (Korea HJ [HJ9820]).

TABLE 2

| | Tensile strength (kgf) | | |
|---|---|---|---|
| | Average | Max. | Min. |
| retroreflective coating yarn, B-5 | 1.26 | 1.26 | 1.24 |
| retroreflective sheeting yarn | 0.44 | 0.44 | 0.43 |
| retroreflective filament | 0.67 | 0.71 | 0.66 |
| composite yarn | | | |

As shown in Table 2, the retroreflective coating yarn according to the present invention has a higher tensile strength than the retroreflective sheeting yarn or the retroreflective filament composite yarn.

From the above experimental results, it can be seen that the retroreflective yarn according to the present invention has excellent brightness and durability.

The retroreflective yarn according to the present invention can be easily recognized at night even with an excellent retroreflective function, so that the retroreflective yarn can be applied to a safety product for protection and also to a fashion product. Further, the retroreflective yarn according to the present invention is low in density of the coating layer and can be reduced in weight, and also is excellent in stretchability. In addition, when the retroreflective yarn according to the present invention is formed into a coated yarn of a multilayer structure, various colors and functions can be realized, and thus it can be utilized as various industrial materials.

In addition, since the manufacturing method according to the present invention does not require separate equipment for high-temperature extrusion, vacuum deposition, etc., it is possible to manufacture retroreflective yarn at a simple facility and at a low cost, thereby improving productivity. The retroreflective yarn according to the present invention can be applied to various products such as clothes, shoes, banners and blinders, thus achieving night safety, non-toxicity, and energy saving effects.

The present invention has been described in detail based on specific embodiments.

It will be apparent to those skilled in the art that this specific description is only a preferred embodiment and that the scope of the present invention is not limited thereby.

1. A retroreflective yarn comprising:
a yarn;
a primary coating layer, coated on the surface of said yarn, comprising an aluminum paste and a thermosetting urethane resin; and
a secondary coating layer, coated on the surface of said primary coating layer with a single layer or a multilayer, comprising an aqueous thermosetting urethane resin, a thickener, a processing aid, and a glass bead.

2. The retroreflective yarn according to claim 1, wherein the primary coating layer comprises 100 parts by weight of the thermosetting urethane resin and 10-40 parts by weight of an aluminum paste.

3. The retroreflective yarn according to claim 1, wherein the secondary coating layer comprises 100 parts by weight of an aqueous thermosetting urethane resin, 1.5-2.5 parts by weight of a thickener, 1-5 parts by weight of a processing aid, and 50-300 parts by weight of glass beads.

4. The retroreflective yarn according to claim 1, wherein the glass bead has an average particle size of about 15-10 μm.

5. The retroreflective yarn according to claim 1, wherein the average thickness of the primary coating layer is about 3-30 μm.

6. The retroreflective yarn according to claim 1, wherein the average thickness of the secondary coating layer is about 10-60 μm.

7. A process for the manufacture of a retroreflective yarn, comprising:
a first step of providing a primary coating composition by mixing a aluminum paste and a thermosetting urethane resin;
a second step of forming a reflective layer by coating the surface of the yarn with the primary coating composition obtained in the first step;
a third step of providing a secondary coating composition by mixing a thickener, a processing aid, glass beads and an aqueous thermosetting urethane resin; and
a fourth step of coating the surface of the yarn obtained in the second step with the secondary coating composition obtained in the third step on in a single layer or in multiple layers.

8. The process according to claim 7, wherein the primary coating composition comprises 100 parts by weight of a thermosetting urethane resin, 10-40 parts by weight of an aluminum paste, and 30-60 parts by weight of a solvent.

9. The process according to claim 7, wherein the secondary coating composition comprises 100 parts by weight of a water-based thermosetting urethane resin, 1-10 parts by weight of a thickener, 1-5 parts by weight of a processing aid, and 50-300 parts by weight of glass beads.

10. The process according to claim 7, wherein the coating of the fourth step proceeds after the reflective layer formed according to the second step is completely cured.

11. A retroreflective yarn produced according to the process of any one of claim 7.

12. A retroreflective yarn produced according to the process of any one of claim 8.

13. A retroreflective yarn produced according to the process of any one of claim 9.

14. A retroreflective yarn produced according to the process of any one of claim 10.
